(19) United States
(12) Patent Application Publication
(10) Pub. No.: US 2009/0259591 A1
(43) Pub. Date: Oct. 15, 2009

(54) Information Rights Management

(75) Inventors: Dmitry Starostin, Aachen (DE); Joris Claessens, Haverlee (BE)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/101,345

(22) Filed: Apr. 11, 2008

(51) Int. Cl. H04K 1/00

(52) U.S. Cl. 705/59

(57) ABSTRACT

Information rights management (IRM) systems are used to protect the use of information within a data item. An IRM system is provided which will allow access to a data item following at least two interactions with one or more licensing entities. In some examples, the license entities may each issue a license containing part of the information required to access the data item. Each license part may correspond to part of a use policy. For example, a first licensing entity may issue a license to access a document based on one requirement and a second licensing entity may issue a license based on a different requirement. In other examples, a licensing entity may require a second licensing entity to perform a validation before it issues a use license.

### BACKGROUND

Information Rights Management (IRM) systems are employed to safeguard the use of sensitive documents. Typically, these systems control access to a data item by defining a policy stating which individuals or groups of individuals should have access to the data item, for example a document, and what level of access should be allowed (for example, one individual/group may have read-only access, while another individual/group has write/edit access to the document). An IRM-protected document is encrypted using a content key, and this key is in turn encrypted, together with the policy, with a key of a licensor service. When a user wishes to access the document, the encrypted content key and policy data is sent the licensor service (typically a remote server) as part of a “use license” request. The licensor can issue use licenses to users who meet the requirements set out in the policy. The use license makes the content key available to the user and contains the set of rights to which that particular user is entitled as defined in the policy.

In such known systems, there is a single decision point, i.e. the point at which the licensor assesses a request from a user and determines whether or not a license should be issued. This limits the versatility of the system.

The embodiments described below are not intended to be limited to implementations that solve any or all of the disadvantages of known IRM systems.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Information rights management (IRM) systems are used to protect the use of information within a data item. This may comprise, for example, allowing an individual user or a class of users to view, but not to edit or print, a document. An IRM system is provided which will allow access to a data item following at least two interactions with one or more licensing entities. In some examples, the license entities may each issue a license containing part of the information required to access the data item. Each license part may correspond to part of a use policy for a data item. For example, a first licensing entity may issue a license to access a document based on one requirement (e.g. membership of a certain group) and a second licensing entity may issue a license based on a different requirement (e.g. the location of the user requesting access). In other examples, a licensing entity may require a second licensing entity to perform a validation before it issues a use license.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a diagram of an apparatus for an exemplary known IRM system;

FIG. 2 is a flow diagram of a method of issuing a license in a known IRM system;

FIG. 3 is a diagram of an apparatus for a generalized IRM system;

FIG. 4 is a flow diagram of a method of issuing a license in the IRM system of FIG. 3;

FIG. 5 is a diagram of an apparatus for an IRM system;

FIG. 6 is a flow diagram of a method of issuing a license in the IRM system of FIG. 5;

FIG. 7 is a diagram of an apparatus for an IRM system;

FIG. 8 is a flow diagram of a method of issuing a license in the IRM system of FIG. 7;

FIG. 9 is a diagram of an apparatus for an IRM system;

FIG. 10 is a flow diagram of a method of issuing a license in the IRM system of FIG. 9;

FIG. 11 is a diagram of an apparatus for an IRM system;

FIG. 12 is a flow diagram of a method of issuing a license in the IRM system of FIG. 11; and

FIG. 13 illustrates an exemplary computing-based device in which the embodiments of FIGS. 3 to 12 may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present examples may be constructed or utilized. The description sets forth the functions of the example and the sequence of steps for constructing and operating the example. However, the same or equivalent functions and sequences may be accomplished by different examples.

As used herein, the term “information rights policy” refers to one or more conditions or criteria which must be met before a user is granted the right to perform a set of specified actions on data, such as “read”, “write”, “print” and “forward”. This differs from policies which might be used solely to control whether data may be obtained from a source without any control over later actions on that data.

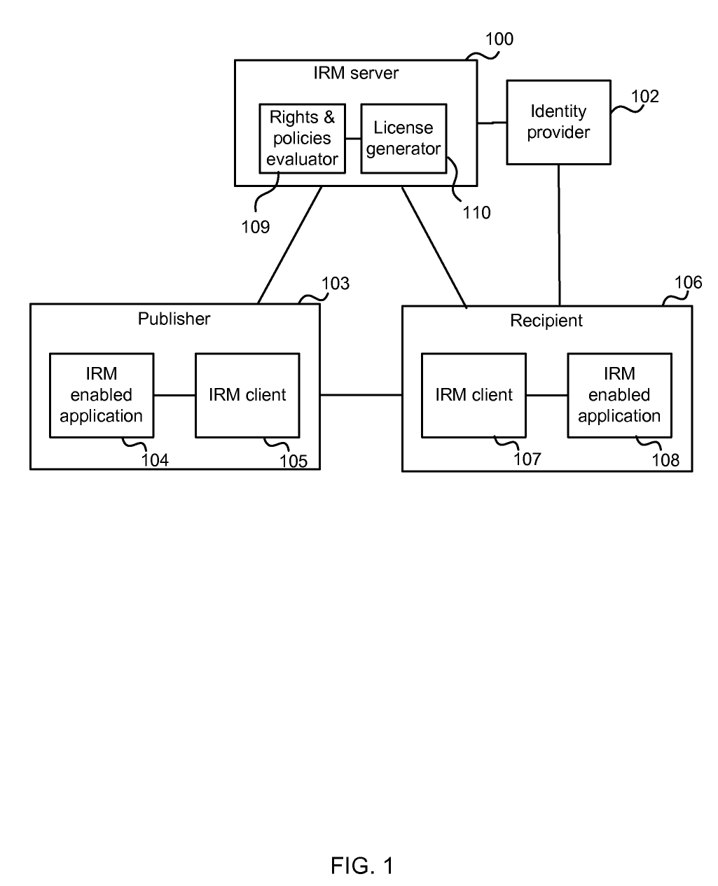

FIG. 1 shows an exemplary known information rights management (IRM) system comprising an IRM server 100, an identity provider 102, a publisher 103 and a recipient 106 all connected by a communications network. The publisher 103 comprises an IRM client 105 and an IRM enabled application 104 such as an email application, a word processing application, or the like. The recipient 106 also comprises an IRM client 107 and an IRM enabled application 108 as available at the publisher 103. There may be many more recipients and publishers although these are not shown in FIG. 1 for clarity. The IRM server 100 comprises a rights and policies evaluator 109 that may be associated with an encrypted data item, and a license generator 110 which is arranged to generate a use license if a user is entitled to access a data item.

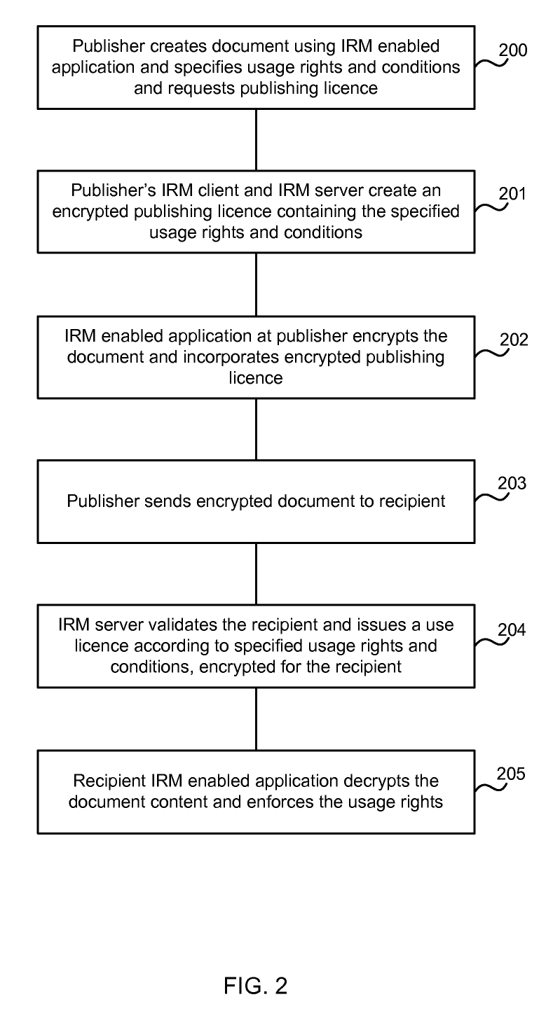

The flow diagram of FIG. 2 shows the processes in creating a document and issuing an authorized user with a license to access the document according to an associated IRM policy. As used herein, and where a distinction is appropriate, the user may be referred to as a “requestor” when requesting to use license and as a “recipient” once it has been determined that the user is authorized to access the document. However, the present disclosure is not concerned with whether an individual qualifies for authorization and therefore, in the examples discussed herein the requestor is generally assumed to be entitled to authorization.

For the sake of clarity, the examples herein generally refer to applying an IRM policy to documents. However, it should be understood that an IRM policy may apply to any data item (for example, emails, spreadsheets, binary data, engineering plans, databases, audit logs and the like), and the disclosure is not limited purely to documents.

The publisher 103 creates a document using the IRM enabled application 104 and specifies usage rights and conditions for the document (block 200). Those usage rights and conditions together form an IRM policy. For example, the conditions may include that the recipient 106 should be a member of a specified group of users (for example, be an employee of a given company) and the usage rights include that the recipient may only view the document (and not edit, print or distribute the document).

The publisher's IRM client 105 and the IRM server 100 together create an encrypted publishing license containing the specified usage rights and conditions (block 201). In this example, the IRM server 100 generates the publishing license and sends this to the IRM client 105. The IRM enabled application 104 or IRM client 105 at the publisher 103 encrypts the document and incorporates the encrypted publishing license into the document (block 202). The publishing license is encrypted with a key of the IRM server 100 (i.e. is encrypted in a manner which the IRM server 100 can decrypt). A content key (which can be used to decrypt the content) is inserted into the encrypted publishing license. As a result only the IRM server 100 is able to issue a use license containing the content key required by the user to decrypt the file.

The publisher 103 then sends the encrypted document together with the publishing license as a file to the recipient 106 (block 203). The recipient 106 opens the file using the IRM enabled application 108 and sends a request for a use license to the IRM server 100. The request includes the recipient's public key and the encrypted publishing license which contains the content key. The IRM server 100 validates the recipient 106 as being in the specified group with reference to the identity provider 102 and creates and issues a use license for the requestor that contains the usage rights and conditions that were specified in the publishing license (block 204). During this process, the IRM server 100 decrypts the content key using its private key and adds the content key to the use license using the recipient's public key in a way that ensures that only the intended recipient can decrypt the key and thus decrypt the protected file. Using the use license, the recipient IRM enabled application 107 or IRM Client 108 then decrypts the document content and enforces the usage rights (block 205).

In the known IRM system described above with reference to FIGS. 1 and 2, the IRM server 100 itself validates the information rights policies and is the only entity able to do this. There is a single policy decision point; i.e. the IRM server 100 decides alone on all conditions within the policy whether a use license should be issued.

This known IRM model can be described as in terms of the notations set out below:

The transformation of a content key and information rights policy (together forming an unsigned license) can be described as:

Issue_{PL}(K_{c}, P)→PL

PL:=└Eₖ_{₁}(K_{c}), Eₖ_{₁}(P)┘

P:=Π[{Rights}, {Expression_{PDP}}]

### Where:

(K_{c},P) is an unsigned license,
P is a use policy, binding usage rights to conditions
P:=Π[{Rights}, {Expression_{PDP}}] is a policy formation which binds the information access rights to the conditions in a policy expression
Π[args] is the formation describing functional dependencies between the arguments Args
{Rights} is the set of usage right which are subject to the policy
{Expression_{PDP}} is the conditions to be evaluated by a policy decision point
PL is the publishing license
K_{c} is a content key (cipher key) used to encrypt plain text/data
Kₗ is a licensor's (e.g. the IRM server's) cipher key
Eₖ( . . . ) is an encryption of the bracketed term with the key k

This transformation can be carried out by the IRM server 100, when the publisher 103 sends the request to the IRM server 100, or by the publisher 103, when the public key of the IRM server 100 is used by the publisher's IRM client 105 to encrypt the content key and the policy.

Normally the publishing license is signed by IRM server 100 or, in the case of offline publishing, by the IRM client 105 on behalf of the IRM server 100 to provide the integrity of the license. In the embodiments discussed herein below, it is assumed that publishing and use licenses are signed.

The use license transformation can be described as:

Issue_{UL}(PL)→UL

UL:=└Eₖ_{ᵣ}(K_{c}),Eₖ_{ᵣ}({Rights })┘,

### Where:

kᵣ is requestor's key and Eₖ_{ᵣ}(K_{c}) is an encryption of the content key K_{C} with kᵣ
{O} is a collection of objects of the same specific type
{Rights} is the set of granted usage rights following the evaluation of the policy [objects] is a set of objects

So-called “Null transformations”, i.e. an encryption/decryption operation with no key, and transformations of a policy with no conditions, can be defined as:

for the key encryption: E₀:=E₀(K)→K

for the policy expressions to rights binding:

Π₀:=Π₀[{Rights}, null]→{Rights}

Thus, the publisher 103, the recipient 106 and IRM server 100 can be described in a unified way as a “licensor” that supports two basic operations:
(i) Issue(Lic)→Lic′, i.e. issue the license. The licensor transforms the input license to the output license and protects it for the target licensor. For example, the IRM server 100 transforms the publishing license into a use license protected for the recipient 106. Or another example, the publisher 103, transforms the unsigned license into a publishing license protected for the IRM server 100.

Extract(Lic,{Rights})→K_{c}, i.e. extract the content key. The licensor obtains the content key if the policy is valid for the requested right(s). For example, the recipient 106 obtains the content key if the requested right is included in the set of granted rights in the use license.

Where a unified license (i.e. both a use and a publishing license) is represented as follows:

$$Lic := [ \begin{matrix}{E}_{{K}_{L}} ( {K}_{C} ) \\ {E}_{{K}_{L}} ( P )\end{matrix} ]$$

With this definition, the licensor actions are interpreted as follows: In order to issue a publishing license, the publisher 103 builds the policy P and sends the request to the IRM server 100 to issue the license or the publisher 103 issues the license itself. The IRM server 100 or the publisher 103 performs an issue operation on the unsigned input license that comprises the content key and policy:

$$Issue ( [ \begin{matrix}{E}_{0} ( {K}_{C} ) \\ {E}_{0} ( P )\end{matrix} ] ) \to [ \begin{matrix}{E}_{{K}_{L}} ( {K}_{C} ) \\ {E}_{{K}_{L}} ( P )\end{matrix} ]$$

In order to issue a use license, the recipient 106 sends a request to the IRM server 100 to issue the use license. The IRM server 100 validates the policy for the recipient 106 and then, if the policy is valid, extracts the content key and issues the use license, including the rights granted according to the policy. The IRM server 100 issues the use license:

$$Issue ( PL ) \to UL or$$

$$Issue ( [ \begin{matrix}{E}_{{K}_{L}} ( {K}_{C} ) \\ {E}_{{K}_{L}} ( P )\end{matrix} ] ) \to [ \begin{matrix}{E}_{{K}_{r}} ( {K}_{C} ) \\ {E}_{{K}_{r}} ( {\prod }_{0} [ \{ Rights \} , null ] )\end{matrix} ]$$

The recipient 106 then extracts the content key from the use license, which will only be allowed by the IRM client 107 if the requested right is part of the set of rights included in the use license.

$$Extract ( [ \begin{matrix}{E}_{{K}_{r}} ( {K}_{C} ) \\ {E}_{{K}_{r}} ( {\prod }_{0} [ \{ Rights \} , null ] )\end{matrix} ] , Right ) \to {K}_{c}$$

Some IRM systems can be termed Context Aware Information Rights Management Systems (CIRMS), an embodiment of which is disclosed in U.S. patent application Ser. No. 11/762,619. In such systems, an IRM server communicates with one or more policy evaluators which are independent of the IRM server and each of which provides a policy decision point. Results from the different policy evaluators are combined by the IRM server. This allows the creation of a single, aggregate set of rights (i.e. the intersection of the granted rights returned by the individual policy decision points).

In known CIRMS embodiments, a complex policy is defined stating who has which access rights to a specific data object: ‘who’ not only refers to identities, but may also include context, such as location, and any other conditions. The policy is defined by the publisher of the data object and/or by the system (including the licensor service). The data object is encrypted with a content key. A publishing license, which includes the defined complex policy, as well as the content key which is encrypted for the licensor service issuing the publishing license (i.e. in a manner which the licensor service can decrypt), is generated and attached to the encrypted data. The publishing license includes security token requirements which are readable by a future license requester.

An application attempting to perform a specific action on the data object on behalf of a recipient triggers that recipient to obtain security tokens as specified in the publishing license, potentially from a plurality of sources. The security tokens together with the publishing license are forwarded to the licensor service, as part of a request to obtain a use license. The licensor service dispatches the policy and the received security tokens to the policy decision point(s) and derives an aggregated set of rights, which have been granted to the recipient by the individual decision points. The licensor service decrypts the content key, and encrypts it again for the application/recipient. The re-encrypted content key together with the set of granted rights is included in a use license with a limited validity time. The application decrypts the data object with the content key and enforces the granted rights, i.e. only performing those actions requested by the recipient that are allowed according to the granted rights set, and only as long the use license is not expired.

In such CIRMS embodiments, the publishing license contains the composite policy that can be evaluated by distributed policy decision points (which therefore provide policy evaluators). Each policy decision point has its context/identity requirements. The recipient presents to the licensor server context/identity requirements along with the publishing license. The licensor server makes the decision about rights of the recipient based on the evaluation results of the policy decision points.

In regards to the CIRMS model, the unified license notation can again be applied:

$$Lic := [ \begin{matrix}{E}_{{K}_{L}} ( {K}_{C} ) \\ {E}_{{K}_{L}} ( Π [ \{ Rights \} , \{ {Expression}_{PDP} \} ] )\end{matrix} ]$$

The license issue notation operation can be extended as follows:

Issue(Lic,{Tokens})→Lic′

Where the {Tokens} collection represents the identity/context information of the requestor; this information is authenticated in the form of security tokens.

The above described CIRMS model still has a single licensor service. Hence, even though complex policies can be expressed as a composition of multiple sub-policies that are possibly evaluated by different policy decision points, the policy evaluation still occurs only during the use license issue/renew request processing at the licensor, which thus acts as a central decision point (i.e. aggregating the decisions of the different policy decision points and putting this into a single license).

There are scenarios, such as the as the scenarios described below, where it may be beneficial for the evaluation of parts of policies to be undertaken and renewed independently, both in terms of time and location, and where it is therefore useful to have multiple licensors, perhaps in a distributed network.

As will become apparent, using the methods and architectures disclosed herein, a document is protected with as many keys as there are licensors. This may be done in several ways, e.g. (i) by applying multiple encryption processes when creating the publishing license, (ii) by deriving an encryption key from the keys of all licensors, (iii) by requiring a licensor to protect its use license with a publishing license for a second licensor, (iv) by requiring a first licensor to seek validation from a second licensor or (v) by a combination of these methods. The distributed setup of licensors described may be statically determined in advance in some examples. In other examples, it may be dynamically decided upon during the processing of a license.

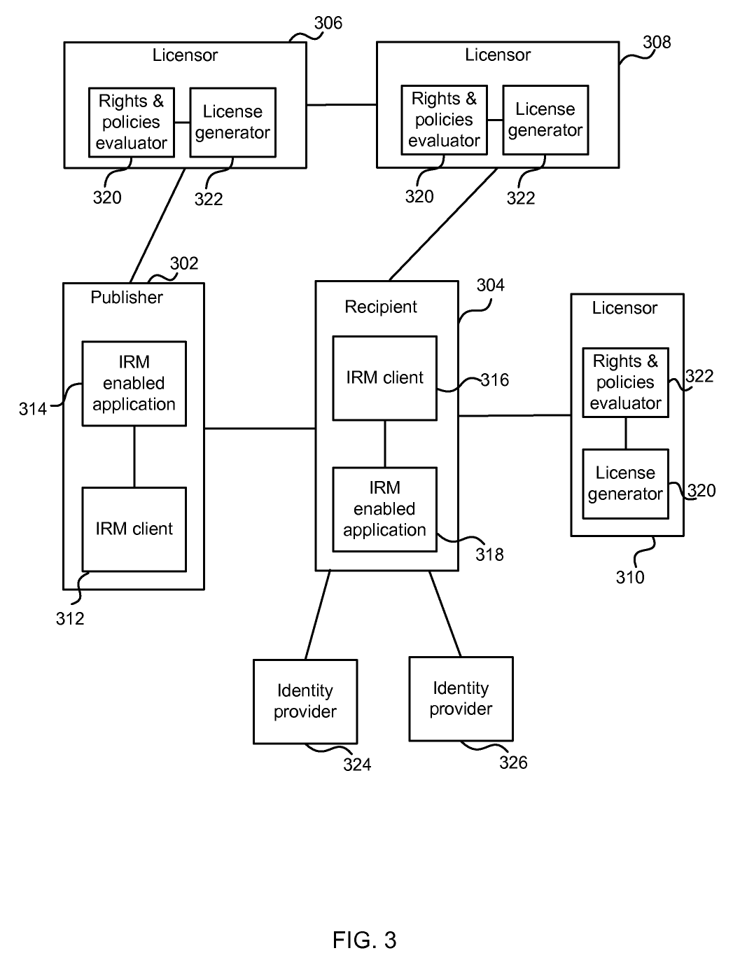

The architecture shown in FIG. 3 is a generic exemplary representation of the entities which make up an IRM system with a plurality of licensors as disclosed herein. The architecture and processing disclosed is such that interaction with all licensors required to validate the conditions mentioned in the policy is required to assess the conditions under which access should be granted, and in order to obtain a fully decrypted content key.

FIG. 3 shows an example IRM system comprising a publisher 302, a recipient computer 304 and a plurality (in this example three) licensors 306, 308, 310. The publisher 302 comprises an IRM client 312 and an IRM enabled application 314 such as a word processing application for example. The recipient computer 304 also comprises an IRM client 316 and the same IRM enabled application 318 as available at the publisher 302. There may be many more recipients and publishers although these are not shown in FIG. 3 for clarity. Each licensor 306, 308, 310 comprises a rights and policies evaluator 320 and a license generator 322. In other examples each licensor may have more than one rights and policies evaluator 320, but this is not shown in FIG. 3 for reasons of simplicity. The system also comprises a plurality of identity providers 324, 326.

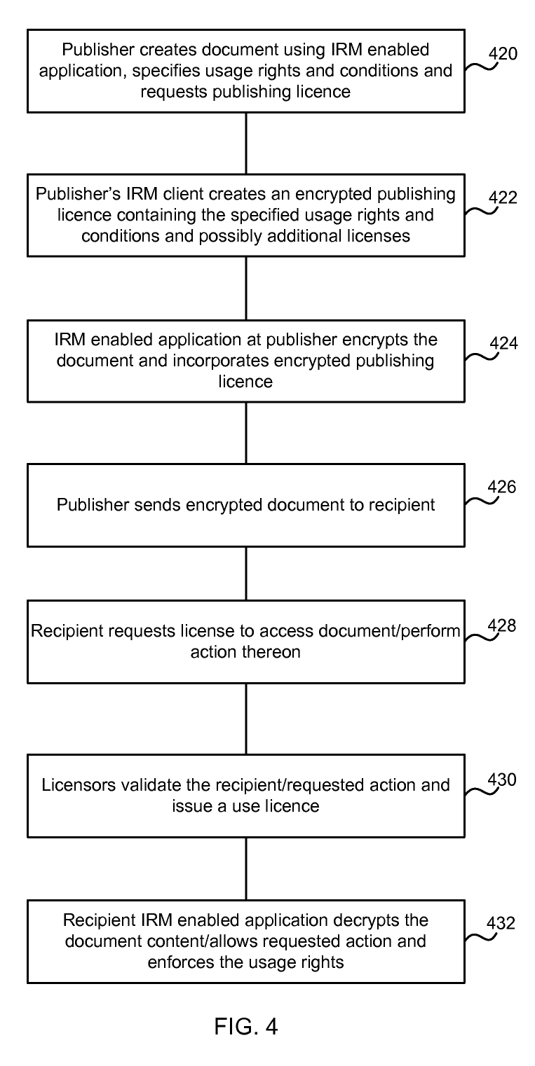

The flow diagram of FIG. 4 shows a generalized process in creating a document and issuing an authorized user with a license to access the document according to an associated IRM policy using the IRM system shown in FIG. 3.

The publisher 302 creates a document using the IRM enabled application 314 and specifies usage rights and conditions for the document (block 420).

The publisher's IRM client 314 together with the licensor 306 creates an encrypted publishing license containing the specified usage rights and conditions (block 422). These conditions for example require validation by at least two of the separate licensors 306, 308, 310.

In some embodiments (which may be arranged differently to the example embodiment shown in FIG. 3), as is discussed in greater detail below, this license may contain the details of one or more of the licensors 306, 308, 310. The IRM enabled application 314 or IRM client 312 at the publisher 302 encrypts the document and packages the encrypted publishing license within the document (block 424). The content key with which the document is encrypted is encrypted with a key of at least one licensor 306, 308, 310 identified in the policy (i.e. is encrypted in a manner which the at least one licensor 306, 308, 310 can decrypt). The encrypted content key is inserted into the encrypted publishing license.

A recipient will only be able to decrypt the content key, and thus the document, if it interacts with each of the licensors 306, 308, 310 from which validations are required. As will become apparent from the description that follows, the use license returned by a licensor may comprise a publishing license for which a recipient requires a use license from a further licensor 306, 308, 310 (e.g. the recipient in FIG. 3 requests a license from licensors 310 and 308) before access to the content of the document is allowed. This is termed a “recursive” process herein. Alternatively or additionally, where the publishing license is encrypted with a key of more than one licensor 306, 308, 310, use licenses from all relevant licensors 306, 308, 310 must be obtained before the content key can be retrieved.

The publisher 302 then sends the encrypted document together with the publishing license to the recipient 304 (block 426). The recipient 304 opens the file using the IRM enabled application 318 and a request for a use license is sent to each of the licensors 306, 308, 310 required to validate the license (block 428). Each of these requests may be sent directly from the recipient 304 or from one or more of the licensors 306, 308, 310. The licensors 306, 308, 310 validate the recipient 304 according to specified criteria (for example, as being in the specified group using the identity providers 324, 326) and create and issue use license(s) which may have a limited validity time and which contains the usage rights that were specified in relation to that licensor 306, 308, 310 in the publishing license (block 430). The recipient's IRM client 316 retrieves encryption keys which are needed in order to decrypt the content key with which the document is encrypted as part of the use licenses from licensors 306, 308, 310. By use of the recipient's key, the use licenses are arranged such that only the intended recipient can access the keys.

Using the use licenses, the recipient IRM enabled application 318 or IRM client 316 then decrypts the document content and enforces the usage rights (block 432). The IRM client 316 will allow the recipient to perform a specific action, if the right to perform that action is granted by each the use licenses from the licensors 306, 308, 310.

The publishing and use licenses may be described as composite license. Extending the notation introduced above, a unified composite license may be defined as:

$$[ \begin{matrix}{E}_{{K}_{L} \{ {K}_{{C}_{{L}_{i}}} \}} ( Kc ) \\ {E}_{{K}_{L}} ( P ) \\ \{ {Lic}_{i} \}\end{matrix} ] = [ \begin{matrix}{E}_{{K}_{L} \{ {K}_{{C}_{{L}_{i}}} \}} ( Kc ) \\ {E}_{{K}_{L}} ( Π [ \{ Rights \} , \{ {Expression}_{PDP} \} ] ) \\ \{ [ \begin{matrix}{E}_{{K}_{{L}_{i}} \{ {K}_{{C}_{{L}_{j}}} \}} ( {K}_{{C}_{{L}_{i}}} ) \\ {E}_{{K}_{L}} ( {P}_{j} ) \\ \{ {Lic}_{j} \}\end{matrix} ] i \}\end{matrix} ]$$

Where:

$${E}_{{K}_{L} \{ {K}_{{C}_{{L}_{i}}} \}} ( Kc )$$

is the content key K_{C} encrypted using key K_{L} of the licensor L and optionally using content keys K_{CL}_{ᵢ} which are protected by child licenses (i.e. licenses which must be evaluated by other licensors).

E_{K}_{_{L}}(P) is the policy, encrypted using key K_{L} of the licensor L

{Licᵢ} is the set of the child licenses, each of which can be a unified composite license, which may include one or more child license Licⱼ.

A processing description which applies to both publishing and use licenses, and also applies to both licensor services and recipients as “licensors”, is now described.

The publishing or use licenses are generated as follows (‘Issue operation’):

The licensor issues derived license L′ to the requestor, where L′ contains the content key from the input license L and the derived policy using the inputs:

$$( i ) Unified composite license = [ \begin{matrix}{E}_{{K}_{L} \{ {K}_{{C}_{{L}_{i}}} \}} ( Kc ) \\ {E}_{{K}_{L}} ( P ) \\ \{ {Lic}_{i} \}\end{matrix} ]$$

(ii) A target licensor identifier, which specifies the encryption key that is used to seal the output derived license and, in some examples
(iii) tokens—{Tokens} collection represents the identity and/or context information of the recipient.

The output of the license derivation is a derived unified composite license

$${Lic}^{′} = [ \begin{matrix}{E}_{{K}_{{L}^{′}} \& \{ {K}_{{CL}_{i}^{′}} \}} ( {K}_{C} ) \\ {E}_{{K}_{{L}^{′}}} ( P ) \\ \{ {Lic}_{i}^{′} \}\end{matrix} ]$$

This license derivation may then be according to the following process:

If the encrypted policy E_{K}_{_{L}}(P) is not NULL then the policy P may be obtained using key K_{L}. Otherwise, and if there are no conditional licenses, a Null license is returned. The policy P can be presented as unencrypted data in the license (this follows from the definition of the NULL encryption transformation above; this is used for example when a publishing license is issued by a publisher from an unsigned license).

In some embodiments, it will be necessary to validate the policy P against tokens {Tokens}. If the validation result comprises the empty {Rights}_{Lic} set then processing is stopped and a NULL license is returned. If the conditional licenses {Licᵢ} set is not empty then a derived licenses {Lic′ᵢ} set is acquired by performing an Issue operation on the corresponding licensor Lᵢ for each Licᵢ recursively. It is assumed that a user or licensor requesting a license knows and trusts the licensor from whom it requests a derived license. It is further assumed that this trust relationship is pre-existing, comprising, for example, a shared key. This disclosure does not include any explicit mechanism to dynamically bootstrap this trust relationship, although the methods and apparatus described herein could be used in conjunction with such a system.

The keys

$$\{ {K}_{{C}_{{L}_{i}}} \}$$

are extracted from the acquired licenses by performing an Extract Key operation (described below) on the current licensor L. The content key K_{C} is obtained using keys K_{L} and

$$\{ {K}_{{C}_{{L}_{i}}} \} .$$

The derived policy P′ is then built. In some examples the derived policy P′ can be the same as the policy P from the input unified composite license (for issuing a publishing license from unsigned license). The derived policy P′ can be the set of rights for the use license case (and if there are conditional use licenses, policy P′ will be intersection of rights from P and from rights in conditional child licenses). The derived policy P′ is then encrypted with the key K_{L′} of the target licensor L′.

New child licenses {Lic′ᵢ} can then be built by performing an issue operation on the corresponding licensors. In some examples the child licenses set is empty. In other examples, the child licenses' policy can be determined independently by the current licensor L, or can be derived (e.g. in the case of unevaluated part of the policy) from the current policy P. The content key K_{C} is then encrypted to the target licensor's key K_{L′} and the content keys

$$\{ {K}_{{C}_{{L}_{i}^{′}}} \}$$

from the corresponding child licenses {Lic′ᵢ}. The derived license Lic′ is returned.

The licensor extracts the content key from the license targeted to this licensor in an ‘Extract key’ operation, which can be defined as follows:

The licensor receives, as its input

$$( i ) the unified composite license = [ \begin{matrix}{E}_{{K}_{L} \& \{ {K}_{{CL}_{i}} \}} ( {K}_{C} ) \\ {E}_{{K}_{L}} ( P ) \\ \{ {Lic}_{i} \}\end{matrix} ] ,$$

(ii) the requested rights {Rights}, and, in some examples,
(iii) the requestor's tokens {Tokens} collection representing the identity and/or context information of the recipient.

The output is the content key K_{C}.

The processing is carried out as follows: If the encrypted policy E_{K}_{_{L}}(P) is not NULL then the policy P is obtained using key K_{L}, otherwise, and if there are no conditional licenses, processing is stopped and a NULL content key is returned.

The policy P is evaluated against the tokens {Tokens} if necessary, and against the requested rights {Rights}. The evaluation result comprises {Rights}_{Lic} and is granted according to the policy. If the requested rights {Rights} set is not a subset of {Rights}_{Lic}, then processing is stopped and a NULL content key is returned. If the conditional licenses {Licᵢ} set is not empty then a derived licenses {Lic′ᵢ} set is acquired by performing an issue operation on the corresponding licensor Lᵢ for each Licᵢ recursively.

The keys

$$\{ {K}_{{C}_{{L}_{i}}} \}$$

are extracted from the acquired licenses by passing the requested {Rights} as parameter and by performing an Extract Key operation on the current licensor L for each Lic′ᵢ. If at least one content key

$${K}_{{C}_{{L}_{i}}}$$

is NULL then processing is stopped and a NULL content key is returned.

The content key K_{C} is extracted using keys K_{L} and

$$\{ {K}_{{C}_{{L}_{i}}} \} .$$

This description above does not describe the expiration times that can be put in a publishing license and a use license. In many embodiments, a use license will have a validity time and will be cached for this period. During this period, the issue and key extraction processes do not need to be repeated. In this disclosure, and as is discussed in more detail hereinafter, account is taken of the validity time of the conditional child licenses recursively. The shortest time should, in particular, be identified. For example, if the validity time of the child license is shorter than the validity time of the parent license, then the issue process should be repeated for the child license accordingly, while if the validity time of the parent license is shorter than the validity time of the child license, then the issue process should be repeated for the parent license, (which will automatically result in a new child license).

The proposed logical structure of the composite license above, and the corresponding processing described above and further explained in each of the example scenarios below, can support any arbitrary distributed setup of licensors by e.g. combining and/or recursively layering composite licenses. This disclosure therefore offers the basic building blocks for any architecture topology.

Examples of the specific entities which may be included in any one IRM system are now discussed with reference to three example scenarios. The process of encrypting the document has been described so will not be described in relation to each example.

In a first example case, the publisher 302 knows which licensors will be validating the request to access the document and the original publishing license created by the publisher can therefore contain aggregated publishing licenses for these different licensors. The content is encrypted with a content key K_{c}, which is then encrypted with a key of a first licensor and with a key of a second licensor. The recipient 304 will need to acquire a use license from both licensors as both use licenses are required to extract the content key. In some examples, this will be two (or more) separate encryption processes; in other examples it could instead be a single encryption with a key derived from the keys of the different licensors.

Using the notation introduced above, the recipient parses the aggregated publishing license, which can be defined as:

$$PL = [ \begin{matrix}{E}_{{K}_{{C}_{L 1 \& {K}_{{C}_{L 2}}}}} ( {K}_{C} ) \\ {PL}_{L 1} \\ {PL}_{L 2}\end{matrix} ]$$

PL_{L1} and PL_{L2} can be a standard or any composite publishing license.

The recipient sends the publishing license PL_{L1} to the first licensor to acquire use license UL1ᵤₛₑᵣ:

$$UL {1}_{user} = [ \begin{matrix}{E}_{{K}_{user}} ( {K}_{{C}_{{L}_{1}}} ) \\ {E}_{{K}_{user }} ( \{ Rights \} {P}_{{L}_{1}} )\end{matrix} ]$$

The recipient then sends the publishing license PL_{L2} to the second licensor to acquire a use license UL2ᵤₛₑᵣ:

$$UL {2}_{user} = [ \begin{matrix}{E}_{{K}_{user}} ( {K}_{{C}_{{L}_{2}}} ) \\ {E}_{{K}_{user }} ( \{ Rights \} {P}_{{L}_{2}} )\end{matrix} ]$$

Using its own key Kᵤₛₑᵣ, the recipient extracts the content keys

$${K}_{{C}_{{L}_{1}}}$$

and

$${K}_{{C}_{{L}_{2}}}$$

from the UL1ᵤₛₑᵣ and UL2ᵤₛₑᵣ correspondingly. The recipient then decrypts the content key K_{C} using the content keys

$${K}_{{C}_{{L}_{1}}} and {K}_{{C}_{{L}_{2}}} .$$

The recipient enforces the intersection of the two rights sets returned in both use licenses.

This scenario can be exemplified by a document which is secured such that it can only be viewed within specific area, for example some restricted zone within the company premises. The document rights permissions policy contains two conditions: first, the condition that the requestor is identified within a directory service which is accessible by the recipient's local area server 400 (i.e. whether the requestor is currently approved in a particular list of individuals who should have access to the document) and second, a location condition, i.e. that the recipient is within the restricted zone.

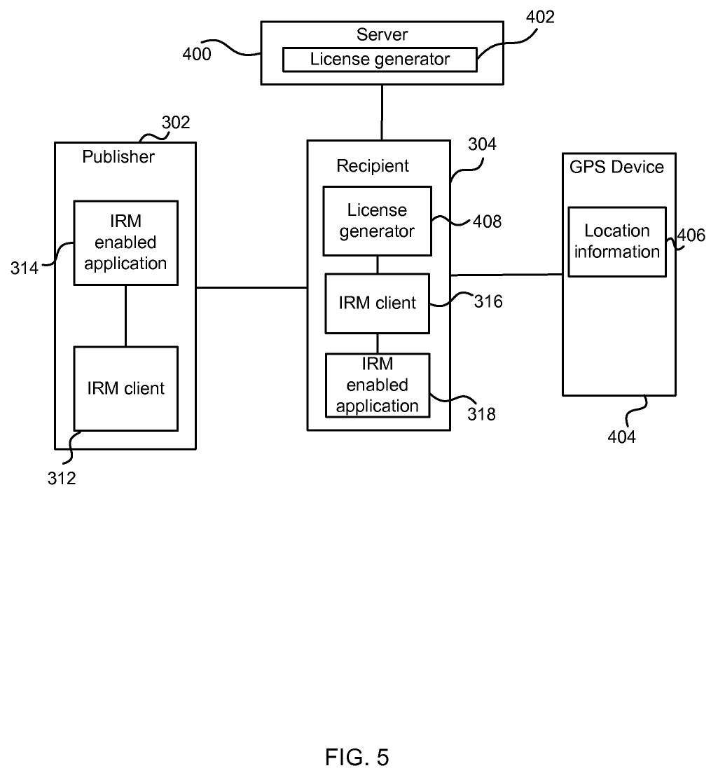

In the embodiment now described and as illustrated in FIG. 5, there is a server license generator 402, which uses data held in the directory service of the local area server 400 and a recipient license generator 408 which uses data produced locally at the recipient's computer 304. Interactions occur with both of these license generators 402, 408 to validate the requestor's attempt to access a document. These license generations 402, 408 provide the first and second licensors and (e.g. public) keys of both license generators are known to the publisher 302.

In this example, GPS data is used to provide the position data but in other examples, alternative data, for example WLAN endpoint data, may be used. In this example, GPS data is provided by a handheld GPS device 404, connected to the recipient's computer 304. More specifically, GPS data is provided by a software component capable of determining location information 406 deployed on this handheld device 404. In such environments, the recipient license generator 408 evaluates the location condition and participates in the licensing process independently from the server generator 402. The license generator 408 could instead be sited on the GPS device 404. The arrangement shown in FIG. 5 assumes that the recipient can be trusted not to tamper with the data provided by the GPS device 404. In case of WLAN endpoints data, the licensor could be a software driver deployed on the requestor computer.

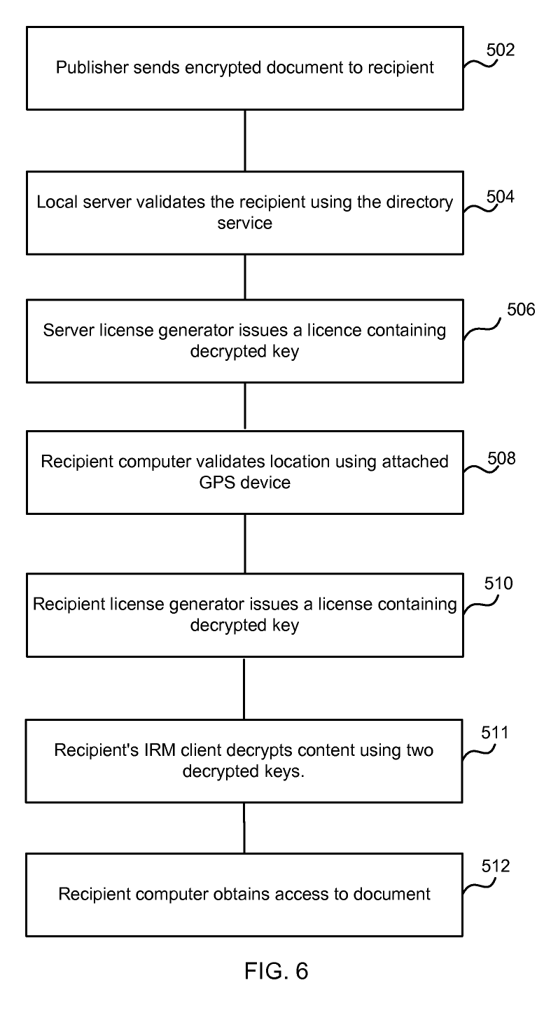

FIG. 6 is a flow chart showing the steps in validating a requestor's attempt to access a document using the IRM system shown in FIG. 5. First, the publisher 302 sends the encrypted document to the requestor computer 304 with the publishing license containing the content key, which is encrypted to a content key from the license for the license generator 408 and to a content key from the license for the license generator 408 (block 502). When the requestor computer 304 attempts to access the content of the document, a request is sent to local server 400 and the requestor's identity is validated against the list held in the directory service (block 504). If (as is assumed herein) the requestor is included in the directory service, then the server license generator 402 issues a license from which its key can be determined and which contains the usage rights and conditions that were specified in the publishing license (block 506). A request is then sent by the recipient license generator to the GPS device 404 to provide GPS data and the requestor computer 304 determines if it is located within the restricted zone (block 508). If (as is assumed herein) the requestor computer 304 is in the restricted zone, the recipient license generator 408 issues a use license which contains a key from the corresponding publishing license (block 510). With both keys produced from the licenses PL1 and PL2, the content key, and thus the content of the document can now be decrypted (block 511) and is made available to the recipient and the limitations specified within both of the use licenses are enforced by the recipient computer 304 (block 512).

As will be appreciated by the skilled person, there are other ways in which the location of a user can be determined. For example, in some environments, the location can be determined by the local area server (in such embodiments, it would be possible for the IRM system to have only one license entity, but this entity would comprise two licensors). Physical access control systems (i.e. systems with access cards) give an example of such kind of environment.

In a second example case, the publisher knows about the identity of one of the licensors (termed the central licensor), but not another. Therefore, the content key is encrypted to a key of the central licensor. When the central licensor validates the policy from the publishing license, it decrypts the content key and it returns a use license which includes an additional conditional publishing license which includes an additional key encrypted to the key of the other licensor. To extract the original content key from the use license, the recipient needs the additional content key which needs to be acquired through an interaction with the other licensor to obtain a use license from the other licensor.

In this example, the recipient sends the publishing license PL_{L1} to the central licensor to acquire use license UL1ᵤₛₑᵣ. The content key and the policy are encrypted for central licensor.

$${PL}_{L 1} = [ \begin{matrix}{E}_{{K}_{L 1}} ( {K}_{C} ) \\ {E}_{{K}_{L 1}} ( {P}_{L 1} )\end{matrix} ]$$

The central licensor validates policy P_{L1} from PL_{L1} and creates conditional publishing license PL_{L2} for another licensor L2. An additional content key K_{C}_{_{L2}} and policy P_{L2} are encrypted for the other licensor.

$${PL}_{L 2} = [ \begin{matrix}{E}_{{K}_{{L}_{2}}} ( {K}_{{C}_{{L}_{2}}} ) \\ {E}_{{K}_{L 2}} ( {P}_{L 2} )\end{matrix} ]$$

The central licensor returns a use license UL1ᵤₛₑᵣ for the recipient. UL1ᵤₛₑᵣ contains the encrypted rights set {Rights}_{P}_{_{L1}} that was evaluated based on the policy in PL1, and conditional publishing license PL_{L2}. The decryption of the rights and the content key not only requires the key of the requesting user, but also the key that was encrypted for the other licensor L2:

$$UL {1}_{user} = [ \begin{matrix}\begin{matrix}{E}_{{K}_{user} \& \{ {K}_{{C}_{{L}_{2}}} \}} ( {K}_{C} ) \\ {E}_{{K}_{user } \& {K}_{{C}_{{L}_{2}}}} ( \{ Rights \} {P}_{L 1} )\end{matrix} \\ {PL}_{L 2}\end{matrix} ]$$

The recipient acquires the Use license UL2ᵤₛₑᵣ for PL_{L2} from the other licensor:

$$UL {2}_{user} = [ \begin{matrix}{E}_{{K}_{user}} ( {K}_{{C}_{{L}_{2}}} ) \\ {E}_{{K}_{user }} ( {\{ Rights \}}_{PL 2} )\end{matrix} ] .$$

The recipient extracts the content key K_{CL}_{₂} from the UL2ᵤₛₑᵣ using own key Kᵤₛₑᵣ and extracts the content key K_{C} using its own key Kᵤₛₑᵣ and the content key K_{CL}₂.

This second scenario can be exemplified by a document rights permissions policy which contains two conditions: first, the condition that the requestor is identified within a directory service which is accessible by the recipient's local area server 400 (i.e. whether the requestor is currently approved in a particular list of individuals who should have access to the document) and second, that the document can be printed to a printer within direct control of the user (in this example within a defined reach, e.g. 20 meters physical reach).

The identity and key of the server 400 is known to the publisher 302, but at the point of applying the IRM policy, it is not known what licensor will validate the printer requirement. Therefore, when encrypting the content key, the publisher 302 utilizes a key of the server 400 and for example includes an instruction in the policy for the server license generator 402 to require a licensing interaction with the appropriate local license generator 408.

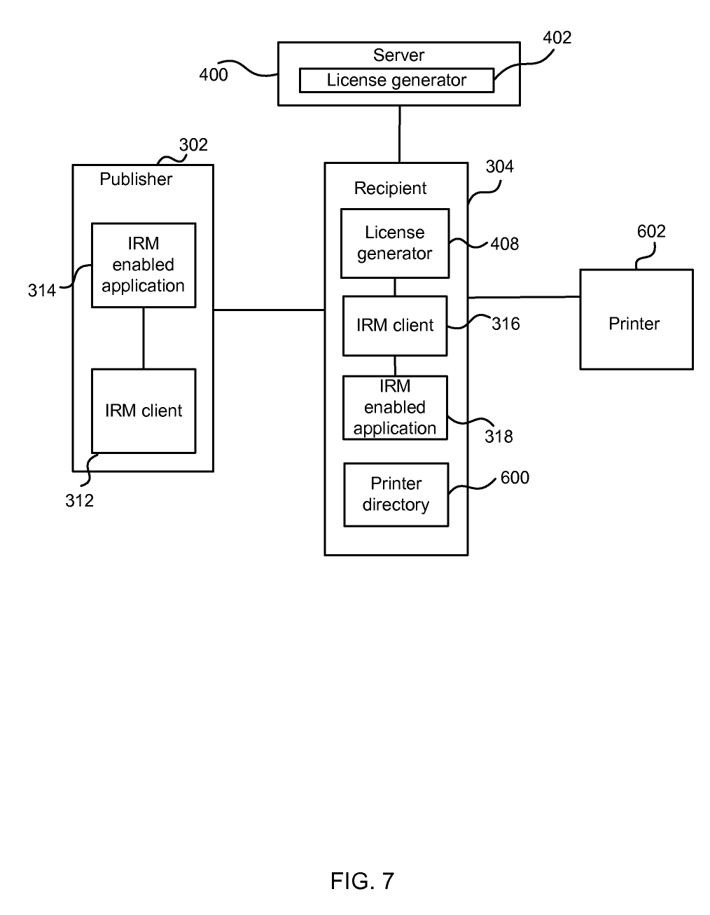

As is shown in FIG. 7, a software driver on the recipient computer 304 again comprises a local recipient license generator 408 in this case. The recipient licensor 408 uses directory services information 600 to determine the location of a printer 602.

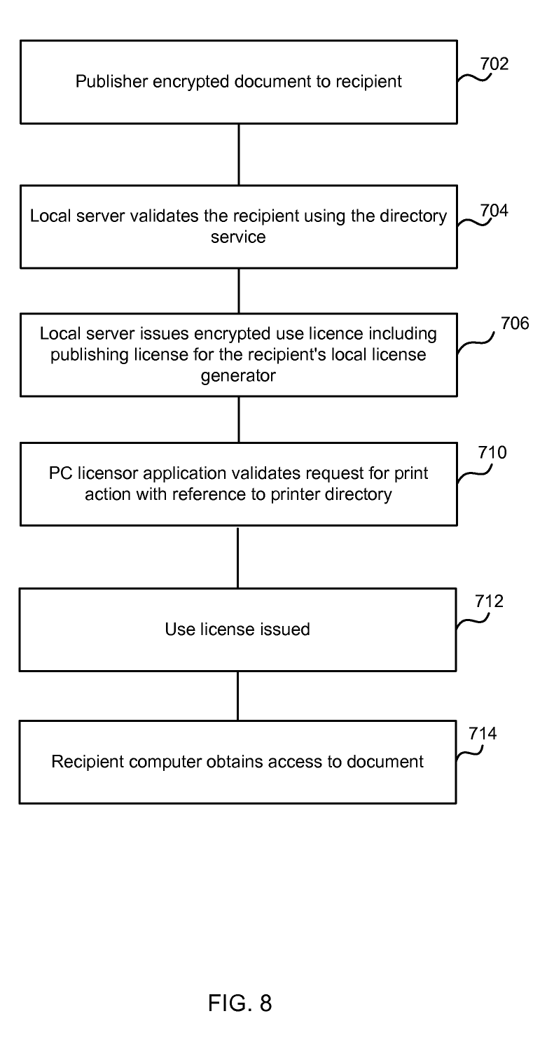

FIG. 8 is a flow chart showing the steps in validating a requestor's attempt to access a document using the IRM system shown in FIG. 7. First, the publisher 302 sends the encrypted document to the requester computer 304 (block 702). When the requester computer 304 attempts to access the content of a document, a request is sent to local server 400 and the requestor's identity is validated against the list held in the directory service (block 704). If (as is assumed herein) the requester is included in the directory service, then the server license generator 402 decrypts the content key and the policy and then re-encrypts the content key and the granted rights with an additional key of the local license generator 408 (block 706).

In order to decrypt the document, the license generator 408 must send a request to the directory services 600 to determine whether the printer 602 is within 20 meters of the recipient (block 710). If (as is assumed herein) the printer 602 is within 20 meters then the recipient license generator 408 returns a use license with the additional key (block 712) and the recipient's IRM client 316 can then decrypt the content key, such that the recipient may then access the document subject to the granted rights (block 710).

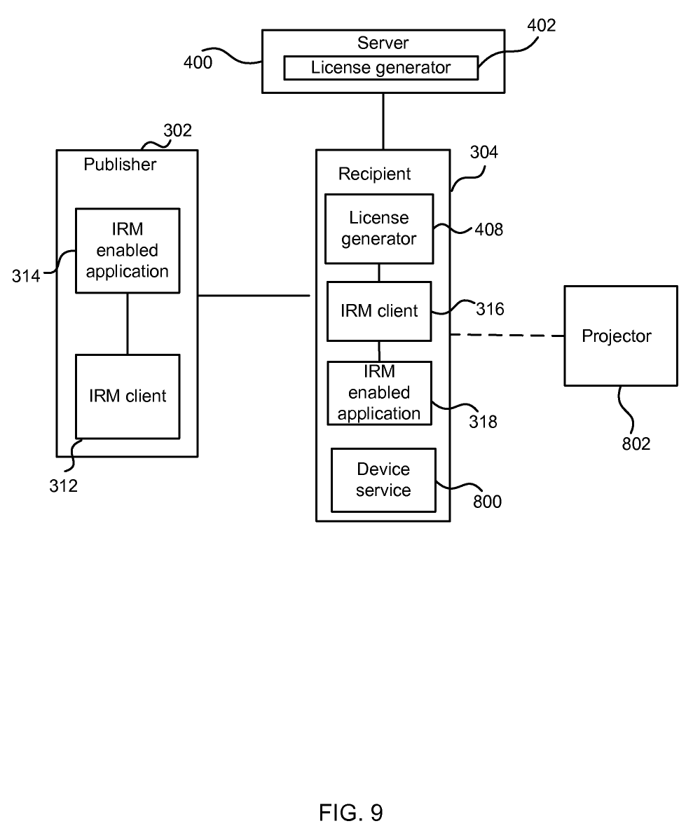

As a further scenario of this second example case, which is shown in FIG. 9, the document rights permissions policy contains two conditions: first, the condition that the requester is identified within a directory service which is accessible by the recipient's local area server 400 (i.e. whether the requester is currently approved in a particular list of individuals who should have access to the document) and second, that the display of the document content is not allowed if a projector is connected to the recipient computer 304. The server's 400 identity is known to the publisher 302, but the identity (and key) of the entity which will validate the requirement regarding projectors is not known.

This additional condition ensures that the document cannot be accidentally exposed to a wide audience. A software driver installed locally on the recipient computer 304 acts as a local license generator 408 that checks if there is any projection device, e.g. a projector 802, connected to the recipient computer 304 (if a projection device is connected then sensitive information could potentially be shown to a larger audience than intended, not just to the recipient).

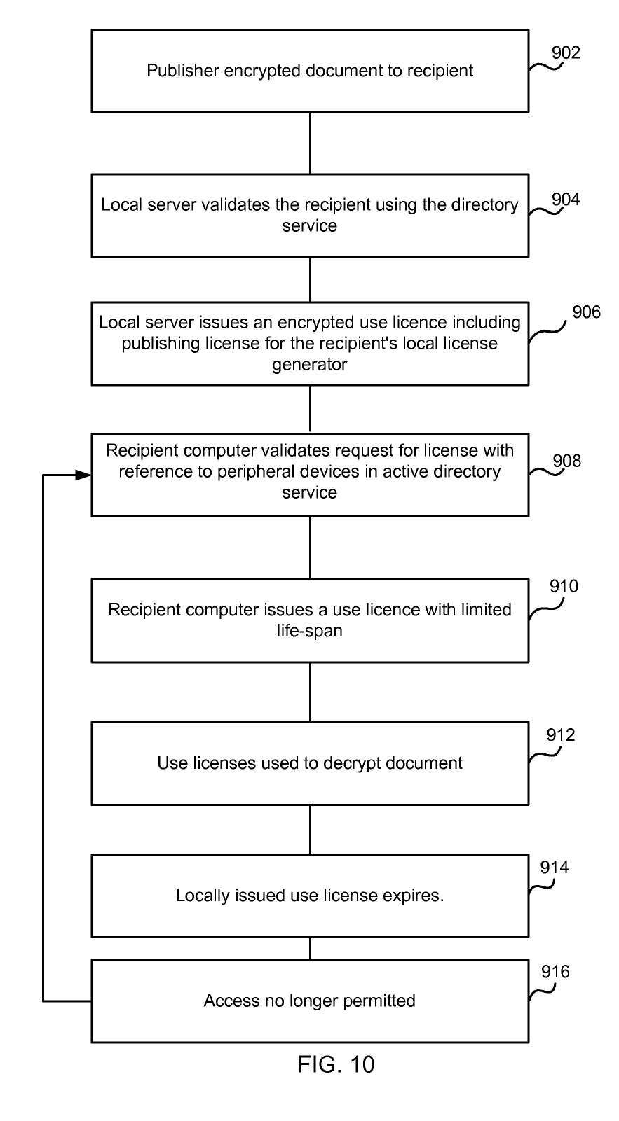

As noted above, a license is usually issued with a limited validity time, i.e. life span. The life span may depend on the policy applied. For example, a license which is issued on the basis that the recipient is a member of a directory security group may have a relatively long validity time of a full working day, as this data is reasonable static. However, for a license issued on the basis that the recipient's computer is not connected to a projector 802, it may be advisable to provide a relatively short life span, for example of a few minutes, as it is simple to connect a projector 802. The example now described with reference to the flowchart of FIG. 10, provides an example of a method in which two license generators 402, 408 may apply policies with different life spans.

FIG. 10 is a flow chart showing the steps in validating a requestor's attempt to access the content of a document using the IRM system shown in FIG. 9. First, the publisher 302 sends the encrypted document to the requester computer 304 (block 902). When the requester computer 304 attempts to access the content of the document, a request is sent to local server 400 and the requestor's identity is validated against the list held in the directory service (block 904). If (as is assumed herein) the requester is included in the directory service, then the server license generator 402 decrypts the content key and the policy containing the usage rights that were specified in the publishing license and re-encrypts the content key and granted usage rights with an additional key protected for the local licensor (block 906). A request is then sent to the device service 800 of the recipient's computer 304 to determine whether a projector 802 is connected to the recipient's computer 304 (block 908). If (as is assumed herein) there are no connected peripheral devices listed, or none of the connected peripheral devices are projectors, the recipient license generator 408 returns a use license to the recipient with a limited lifespan, and including the additional key (block 910). The content of the document will now be made available to the recipient according to the limitations specified within the use license (block 912).

After its specified life span (which in this example is shorter than that of the server issued use license), the use license issued by the local licensor 408 times out (block 914). New attempts to access (e.g. display) the document will not be allowed under the control of the recipient's IRM client 116 (block 916) until it is determined whether the recipient has connected a projector to their computer 304 since the license was issued.

As will be appreciated by the skilled person, this period of suspension of access may not become apparent to a user. As the process required to re-validate the user comprises checking a local directory, this can be carried out relatively quickly (and with relatively little computing power). It will be noted that performing this check does not require access to a network and therefore it will not be delayed by any connectivity issues such as heavy network traffic or a lost connection. The check, and the issuance of a new use license, may therefore be accomplished before a user becomes aware that access is no longer allowed, for example immediately when the use license expires.

Of course, in other examples, peripheral devices other than projectors may be considered in the licensing processes (for example, speakers, USB drives, etc).

In a third example case, the original publishing license created by the publisher contains a dependent publishing license for a delegated licensor. This means that a first licensor has to acquire a child use license from the delegated second licensor. The first licensor can then decrypt the policy from the publishing license, validate it and return the overall use license to the recipient. The key of both licensors is known at the time of creating the publishing license.

The recipient sends the publishing license PL_{L1} to the first licensor to acquire Use license UL1ᵤₛₑᵣ.

$${PL}_{L 1} = [ \begin{matrix}\begin{matrix}{E}_{{K}_{L 1} \& {K}_{{C}_{{L}_{2}}}} ( {K}_{C} ) \\ {E}_{{K}_{L 1} \& {K}_{{C}_{{L}_{2}}}} ( {P}_{L 1} )\end{matrix} \\ {PL}_{{L}_{2}}\end{matrix} ]$$

The first licensor acquires the use license UL2_{L1} for PL_{L2} from the second licensor.

$$UL {2}_{L 1} = [ \begin{matrix}{E}_{{K}_{L 1}} ( {K}_{{C}_{L 2}} ) \\ {E}_{{K}_{L 1}} ( {\{ Rights \}}_{PL 2} )\end{matrix} ] .$$

Only after obtaining UL2_{L1} the first licensor is able to decrypt and validate policy P_{L1} from PL_{L1}, and then builds and returns the use license UL1ᵤₛₑᵣ for the recipient. The granted rights returned to the recipient are the intersection of the rights granted according to P_{L1} and P_{L2}.

$$UL {1}_{user} = [ \begin{matrix}{E}_{{K}_{user}} ( {K}_{C} ) \\ {E}_{{K}_{user}} ( {\{ Rights \}}_{PL 1} )\end{matrix} ]$$

The recipient extracts the content key K_{C} using own key Kᵤₛₑᵣ from the use license UL1ᵤₛₑᵣ.

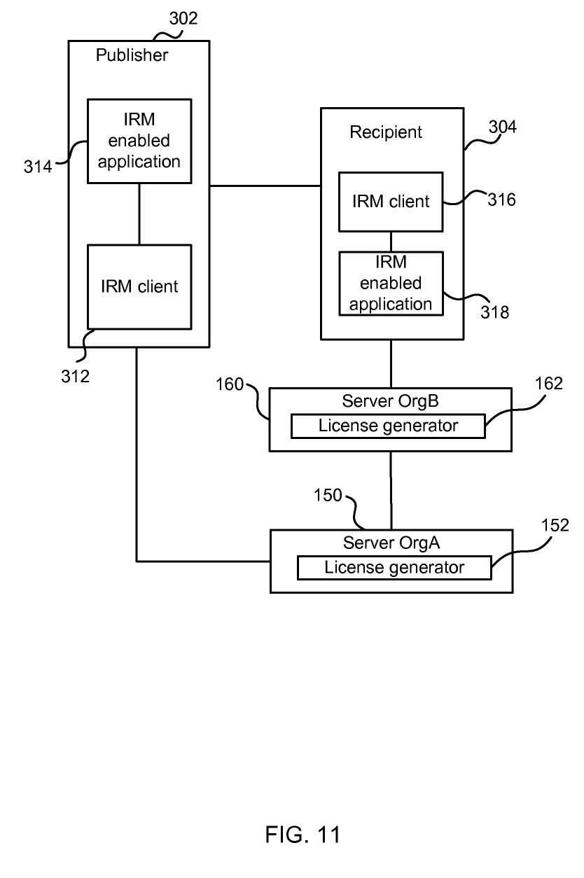

An example of this scenario considers federated IRM servers, and is shown schematically in FIG. 11. The usage policy requires two validation stages before a license is granted to a recipient. The policy states that a document can be shared with anyone who is known and trusted by Organization A to work in a specified collaborative project X.

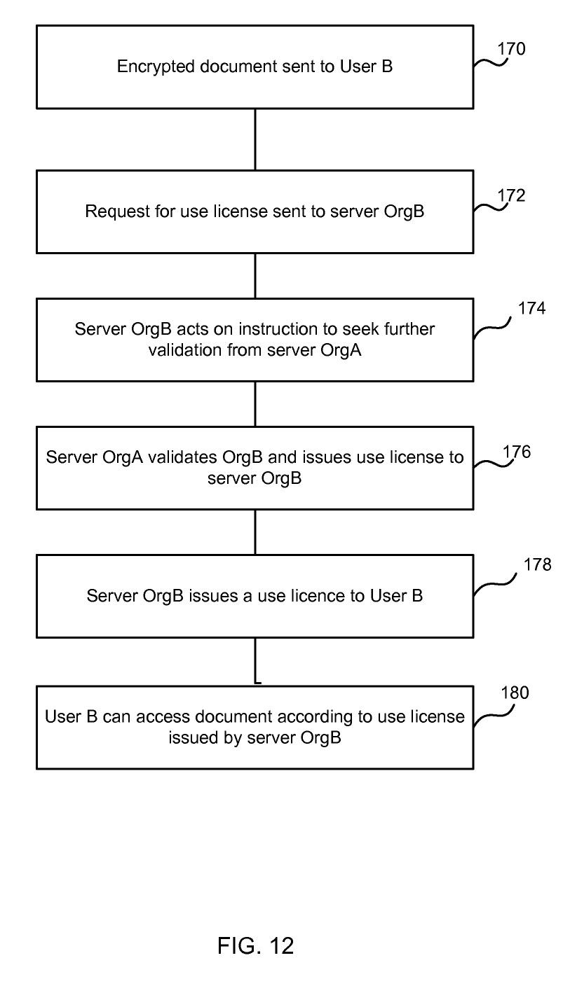

In this scenario (as is explained with reference to the flowchart of FIG. 12), user A authors a document with a publishing license from Organization A's IRM server 150, stating a general policy that the information in the document can be shared with anyone who is known and trusted by Organization A to work in a specified collaborative project X.

The document is packaged in a specific way as outlined above (block 170) such that that when user B from Organization B attempts to access the data, recipient B is prompted to request a use license from Organization B's IRM server 160 (block 172). Organization B's IRM server 160 will use its licensor 162 to validate recipient B's involvement in project X. However, before Organization B's IRM server can generate a use license for user B, Organization B's IRM server must obtain a use license from Organization A's IRM server 150 (block 174). This allows Organization A to validate whether Organization B is trusted (block 176). If so, the server of Organization A will return a use license including a key which allows Organization B's IRM server 160 to decrypt the content key, and issue a use license to user B (block 178). User B can then access the document according to the granted rights included in the use license issued by Organization B's IRM server 160 (block 180).

The scenarios above provide some examples of a wide range of scenarios in different applications and industry domains, where sharing of information is required in a controlled fashion. As will be appreciated from the foregoing, this includes IRM systems in which there are multiple licensors which are distributed in the system, and which may re-issue granted rights at different times.

Although some measures disclosed herein increase security, this disclosure is not specifically concerned with the threat models of the systems disclosed herein. It is assumed herein that the client application and environment—and ultimately the user—are trusted to effectively enforce/obey the granted rights, when the user has access to the information. Recipients that are not entitled to any access rights to the information are restrained from doing so cryptographically. Of course, in live systems, there may be other security measures which are undertaken in conjunction with the IRM system disclosed herein.

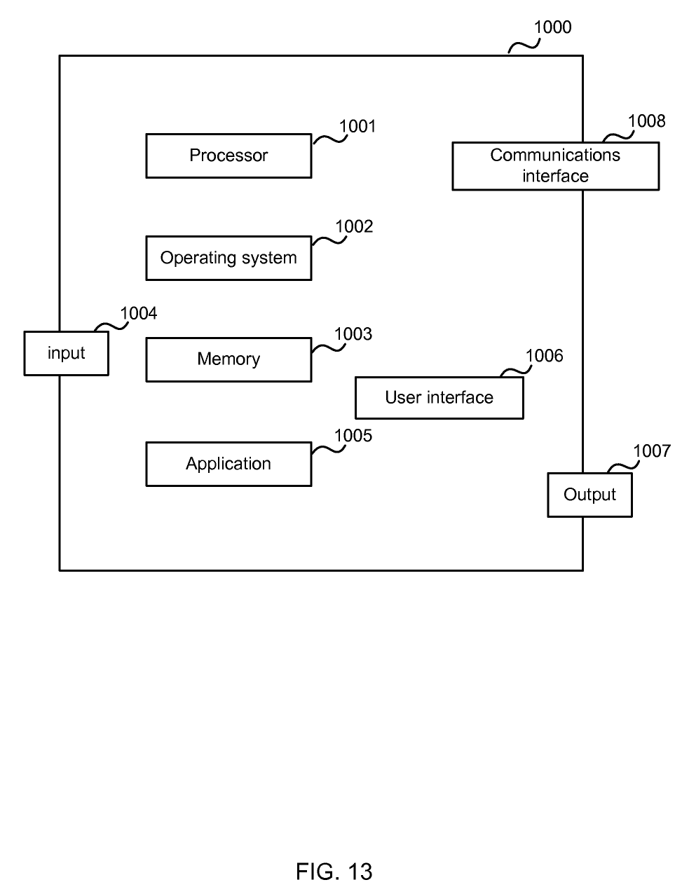

FIG. 13 illustrates various components of an exemplary computing-based device 1000 which may be implemented as any form of a computing and/or electronic device, and in which embodiments of an information rights management server, a publisher 302, a recipient computer 304 or a licensor may be implemented.

The computing-based device 1000 comprises one or more inputs 1004 which are of any suitable type for receiving inputs such as an input from a recipient a comprising issue license request and the like. The device 1000 also comprises a communication interface 1008 for communicating with other entities such as information rights management servers, recipients, publishers and other communications network nodes.

Computing-based device 1000 also comprises one or more processors 1001 which may be microprocessors, controllers or any other suitable type of processors for processing computing executable instructions to control the operation of the device in order to carry out the functions of an information rights management server, a publisher or a recipient. Platform software comprising an operating system 1002 or any other suitable platform software may be provided at the computing-based device to enable application software 1005 to be executed on the device 100.

The computer executable instructions may be provided using any computer-readable media, such as memory 1003. The memory is of any suitable type such as random information memory (RAM), a disk storage device of any type such as a magnetic or optical storage device, a hard disk drive, or a CD, DVD or other disc drive. Flash memory, EPROM or EEPROM may also be used.

An output 1007 may also be provided such as an audio and/or video output to a display system integral with or in communication with the computing-based device. The display system may provide a graphical user interface, or other user interface of any suitable type although this is not essential.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment/example or may relate to several embodiments/examples. The embodiments/examples are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A method of information rights management comprising the steps of:
receiving a request for a publishing license for a data item, the request comprising information rights policy details including conditions which require validation by at least two licensors;
encrypting the data item with a content key;
issuing a publishing license on the basis of the information rights policy details, the publishing license comprising at least one of:
(i) an encryption of the content key using a key derived from keys protected by at least two licensors, requiring validation of at least one policy condition by each of these licensors;
(ii) an encryption of the content key with a key of a first licensor and an information rights policy resulting in an instruction for a re-encryption of the content key with a key of at least a second licensor, requiring validation of at least one policy condition by at least the second licensor;
(iii) an encryption of the content key with a key of a first licensor and with at least one key protected by at least one further licensor, requiring validation of at least one policy condition by the at least one further licensor.

2. A method as claimed in claim 1 in which the publishing license comprises an encryption of content key with content keys of child publishing licenses to be processed by corresponding licensors, the method further comprising receiving a request for a use license from a user at least the first and the second licensors, each request comprising a publishing license.

3. A method as claimed in claim 2 which further comprises validating the request for a license at least the first and the second licensors and, at each licensor, if the conditions to be validated thereby are met, issuing a use license comprising the key decrypted by that licensor.

4. A method as claimed in claim 3 in which the use license issued licensor is encrypted to a key of the user.

5. A method as claimed in claim 2 in which at least one of the license issued by the first licensor and the license issued by the second licensor has a lifespan, the method comprising, on expiry of the life span, preventing further access to the data item.

6. A method as claimed in claim 1 in which the publishing license comprises a rights policy resulting in an instruction to re-encrypt the content key with a key of a second of the licensors, the method further comprising receiving a request for a use license from a user at the first licensor, and, if the conditions to be validated thereby are met, issuing at the first licensor, as part of a use license which comprises the key of the first licensor, a conditional publishing license comprising a content key and a policy encrypted for the second licensor.

7. A method as claimed in claim 6 which further comprises receiving the conditional publishing license at the second licensor, and, if the conditions to be validated thereby are met, issuing at the second licensor a use license which comprises the key decrypted by that licensor.

8. A method as claimed in claim 7 in which at least one of the license issued by the first licensor and the license issued by the second licensor has a lifespan the method comprising, on expiry of the life span, preventing further access to the data item.

9. A method as claimed in claim 7 in which the use license issued by at least one licensor is encrypted to a key of the user.

10. A method as claimed in claim 1 in which the publishing license comprises a dependent publishing license requiring the validation of a policy condition by reference to a second licensor, the method further comprising receiving a request for a use license from a user at the first licensor, causing the first licensor to acquire a use license from the second licensor and, if the use license is obtained from the second licensor, issuing at the first licensor a use license which comprises the key decrypted by that licensor.

11. A method as claimed in claim 10 in which the use license issued by the first licensor comprises a content key which is encrypted to the key of the user.

12. A method as claimed in claim 10 in which at least one of the license issued by the first licensor and the license issued by the second licensor has a lifespan the method comprising, on expiry of the life span, preventing access to the data item.

13. An information rights management licensor comprising:
an input arranged to receive a request for a use license, wherein the license is required in order to access the content of a data object;
a processor arranged to validate the request for a license on the basis of information rights policy conditions and to generate a use license comprising a publishing license encrypted with a key of at least one other licensor; and
an output arranged to issue a license including the instruction to request a license from at least one other licensor.

14. An information rights management licensor as claimed in claim 13 which comprises a component of an IRM server.

15. An information rights management licensor as claimed in claim 14 which comprises a component of a recipient computer.

16. One or more device-readable media with device executable instructions for building a composite license for an information rights management system comprising the steps of:
(i) acquiring a data item with an information rights management policy and a content key;
(ii) performing an encryption of a content key for the data item and of information rights management policy using the key of at least a first licensing entity;
(iii) building the composite license with the encryption of the content key, the encryption of the information rights management policy and a set of child licenses which includes conditions which are validatable by at least a second licensing entity.

17. One or more device-readable media with device executable instructions for building a composite license for an information rights management system according to claim 16 further comprises the step of performing an encryption of the content key using the key of a second licensing entity.

18. One or more device-readable media with device executable instructions for building a composite license for an information rights management system according to claim 16 in which the set of child licenses is a null set.

19. One or more device-readable media with device executable instructions for building a composite license for an information rights management system according to claim 16 in which the composite license is a use license.

20. One or more device-readable media with device executable instructions for building a composite license for an information rights management system according to claim 16 in which the composite license is a publishing license.
